(19) United States
(12) Patent Application Publication
(10) Pub. No.: US 2014/0052531 A1
(43) Pub. Date: Feb. 20, 2014

(54) AUTOMOTIVE DIAGNOSTICS AND MARKETING SYSTEMS AND METHODS

(71) Applicants: Justin K. Kent, Springville, UT (US); Timothy A. Tabor, West Jordan, UT (US)

(72) Inventors: Justin K. Kent, Springville, UT (US); Timothy A. Tabor, West Jordan, UT (US)

(73) Assignee: UNIGLASS, L.L.C., Provo, UT (US)

(21) Appl. No.: 13/589,014

(22) Filed: Aug. 17, 2012

(51) Int. Cl. G06Q 30/02; G06F 7/00

(52) U.S. Cl. 705/14.49; 701/31.5

(57) ABSTRACT

Implementations of the present invention relate to systems, methods, and apparatus for providing marketing materials related to recommended service, maintenance, repair, and combinations thereof for a particular vehicle. In at least one implementation, a vehicle diagnostics monitor can read various parameters from the vehicle's OBD connection. The vehicle parameters then can be used to identify and recommend services and repairs to be performed on a vehicle as well as to provide marketing materials related to such services and repairs.

### CROSS-REFERENCE TO RELATED APPLICATIONS

N/A.

### BACKGROUND OF THE INVENTION

1. The Field of the Invention

This invention relates to systems, methods, and apparatus for receiving marketing and advertising automotive services.

2. Background and Relevant Art

Typical vehicles require routine checkups, maintenance, and service of various components and systems. For instance, such maintenance or service may be required by a manufacturer of the vehicle, in order to ensure proper operation and longevity of the vehicle's components. Furthermore, some manufacturers may invalidate the vehicle's warranty, if the vehicle has not had required, scheduled maintenance. Accordingly, in order to extend the vehicle's life and/or fulfill warranty requirements, the onus of maintaining the vehicle frequently falls upon the vehicle's owner.

For example, a typical vehicle requires periodic oil changes, which may depend on various factors (e.g., number of miles driven). Hence, the owner of the vehicle has to be diligent about making timely oil changes, in order to avoid damaging the vehicle's engine and/or to avoid invalidating the manufacturer's warranty. Commonly, after changing oil, a service shop may place a reminder sticker on the vehicle's windshield, providing the owner with the mileage number for a subsequent oil change.

Then, the vehicle's owner may periodically compare the vehicle's odometer reading with the mileage on the reminder sticker. When the mileage provided on the reminder sticker is approximately the same as the mileage on the vehicle's odometer, ordinarily, the owner brings the vehicle to a service shop for another oil change. Constantly comparing the mileage on the odometer to the mileage on the reminder sticker can be burdensome and/or bothersome, and the owner may frequently forget to do so.

Furthermore, many owners can be price-conscious and may like to obtain the best possible deal available at the time of their service (e.g., best deal on an oil change). Finding the best deal, however, may require time and effort from the vehicle's owner and, at times, may not be possible due to immediacy of the service requirement. For example, the vehicle may already have exceeded the number of miles recommended between oil changes and may require immediate attention.

As the vehicle owners may have to service their vehicles immediately, oftentimes, service shops providing the best deals for a particular service may not be able to reach such owners. In other words, service shops marketing their services at a discounted price (e.g., in order to attract new customers) may not be able to reach such customers at the time when a particular service is needed. Consequently, there may be a mismatch between the buyers and sellers of a particular service, which can lead to an inefficient marketplace. In other words, suboptimal pricing of the services by the service shops as well as suboptimal expenditures by the vehicle owners during the life of the vehicle.

In addition, often times a vehicle will experience some type of malfunction that causes the vehicle to perform at a suboptimal level or not at all. Typically to diagnose the malfunction, an owner is required to drive to a service shop. The service shop can determine the source of the malfunction and the cost to repair the malfunction. Unfortunately, taking one's vehicle to service shop for diagnosis is often time consuming and inconvenient.

More specifically, most vehicles since 1996 include an on-board diagnostics (OBD) that monitors the vehicle's emission control systems to detect any malfunction or deterioration that causes emissions to exceed EPA-mandated thresholds. Second generation of on-board diagnostics (OBD-II) also monitor other vehicle parameters in addition to emissions. In particular, OBD-II systems monitor a wide range of data that is indicative of the performance of the vehicle. For example, OBD-II systems can monitor vehicle speed, mileage, engine temperature, and intake manifold pressure. OBD-II systems can also query manufacturer-specific data, such as data relating to the vehicle's engine, transmission, brakes, alarm, and entertainment systems. OBD-II systems also monitor codes called fault or diagnostic trouble codes, or “DTCs”, which indicate a mechanic or electrical problem with the vehicle.

When service shops diagnose a vehicle, the service shop may use an external engine-diagnostic equipment to query the vehicle's OBD-II system. By querying the vehicle's OBD-II system, the service shop can determine whether or not a specific component of the vehicle has malfunctioned. One will appreciate that external engine-diagnostic equipment can make the service process more efficient and cost-effective. Unfortunately, a vehicle owner is required to take their car into a service shop in order to take advantage of the ability to use external engine-diagnostic equipment.

Accordingly, there are a number of disadvantages in current vehicle diagnostic and maintenance that can be addressed.

### BRIEF SUMMARY OF THE INVENTION

Implementations of the present invention solve one or more of the foregoing or other problems in the art with systems, methods, and apparatus for providing marketing materials related to recommended or needed service, maintenance, repair, and combinations thereof for a particular vehicle. In at least one implementation, a vehicle diagnostics monitor can read various parameters from the vehicle's OBD connection, and such parameters can indicate whether the vehicle would benefit from being serviced and/or repaired. Particularly, a computer system can receive the vehicle parameters and, based on the parameters, can identify or recommend services and/or repairs to be performed on a vehicle.

At least one implementation includes a method of delivering marketing material to owners and operators of vehicles, which is practiced at a computer system, the computer system including one or more processors and a memory. The method includes receiving a transmission of vehicle parameter readings from a vehicle diagnostics monitor installed on the vehicle. The method also involves obtaining diagnostic information about the vehicle by decoding the vehicle parameter readings received from the vehicle diagnostics monitor based on a predetermined protocol. The method further includes identifying one or more of recommended maintenance, service, and repair for the vehicle based at least in part on the vehicle's diagnostic information. Additionally, the method involves sending marketing materials for the identified one or more of recommended or needed maintenance, service, and repair to one or more of the vehicle's owners and operators.

Another implementation includes a system for receiving marketing materials related to vehicle service, maintenance, repair, and combinations thereof. The system includes a vehicle diagnostics monitor having a system memory and a processor. The vehicle diagnostics monitor is configured to connect to an OBD connection of the vehicle and query one or more vehicle parameters. The vehicle diagnostics monitor is further configured to store the one or more vehicle parameters in the system memory. The vehicle diagnostics monitor is further configured to locate and access an available Wi-Fi network connection. Additionally, the vehicle diagnostics monitor is configured to transmit the one or more stored vehicle parameters over the Internet through the available Wi-Fi network connection. The system also can include a backend system that has one or more host computers connected to the Internet. Moreover, the backend system is configured to receive the one or more stored vehicle parameters from the vehicle diagnostics monitor and to identify one or more of recommended maintenance, service, and repair for the vehicle based on the received vehicle parameters. Furthermore, the backend system is configured to send marketing materials to an owner or operator of the vehicle based at least in part on the transmitted vehicle parameters. Additionally, the system includes a communication device of the vehicle's owner or operator, the communication device being configured to receive marketing materials from the backend system.

Yet another implementation includes a device for reading and transmitting one or more vehicle parameters to a backend system using a Wi-Fi network. The device has an OBD interface configured to connect to an OBD connection of the vehicle. The device also includes a processor in electronic communication with the OBD interface. The processor is configured to receive and process the one or more vehicle parameters from the OBD interface. The device also has a memory in electronic communication with the processor. The memory is configured to receive and store the one or more vehicle parameters. The device further includes a Wi-Fi transmitter in electronic communication with the processor. The processor and the Wi-Fi transmitter are configured to cooperate and to access an available Wi-Fi network connection for transmitting the one or more vehicle parameters over the available Wi-Fi network connection. Moreover, the device includes a power supply configured to receive power from the OBD interface and to transmit power to one or more of the processor, memory, and the Wi-Fi transmitter.

Additional features and advantages of exemplary implementations of the invention will be set forth in the description which follows, and in part will be obvious from the description, or may be learned by the practice of such exemplary implementations. The features and advantages of such implementations may be realized and obtained by means of the instruments and combinations particularly pointed out in the appended claims. These and other features will become more fully apparent from the following description and appended claims, or may be learned by the practice of such exemplary implementations as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. For better understanding, the like elements have been designated by like reference numbers throughout the various accompanying figures. Understanding that these drawings depict only typical embodiments of the invention and are not therefore to be considered to be limiting of its scope, the invention will be described and explained with additional specificity and detail through the use of the accompanying drawings in which:

FIG. 1A illustrates a perspective view of a vehicle diagnostics monitor in accordance with one implementation of the present invention;

FIG. 1B illustrates a schematic view of components of the vehicle diagnostics monitor of FIG. 1A;

FIG. 2 illustrates a schematic view of a system for receiving marketing materials related to vehicle service, maintenance, and repair in accordance with one implementation of the present invention;

FIG. 3A illustrates a schematic view of a user interface of a main webpage of a vehicle information website in accordance with one implementation of the present invention;

FIG. 3B illustrates a schematic view of a user interface of a webpage providing additional information on the vehicle information website in accordance with one implementation of the present invention; and

FIG. 4 illustrates a flowchart of a series of acts in a method in accordance with an implementation of the present invention of providing marketing and advertising information to vehicle owners.

### DETAILED DESCRIPTION OF THE PREFERRED EMBODIMENTS

Implementations of the present invention provide systems, methods, and apparatus for providing marketing materials related to recommended service, maintenance, repair, and combinations thereof for a particular vehicle. In at least one implementation, a vehicle diagnostics monitor can read various parameters from the vehicle's OBD connection, and such parameters can indicate whether the vehicle may benefit from being serviced and/or repaired. Particularly, a marketing system can receive the vehicle parameters and, based on the parameters, can identify and/or recommend services and/or repairs to be performed on a vehicle.

More specifically, typical modern vehicles have one or more onboard computers that monitor and/or control numerous parameters, functions, and systems. As used herein in connection with a vehicle, unless otherwise specified or defined, the term “parameters” refers to generally to any electronic parameter, setting, or reading that can be obtained from, sent to, or modified at or by the vehicle's onboard computer(s). For instance, the onboard computer(s) may monitor engine temperature and oxygen levels and control the fuel injectors (e.g., to deliver an optimal amount of fuel into the engine's combustion chamber). The onboard computer(s)can monitor hundreds of various parameters of the vehicle, which may vary from one manufacturer to another.

In addition to, or in lieu of, monitoring and controlling various parameters and functions, the onboard computer(s) also can provide information about the vehicle parameters via the vehicle's OBD connection. In particular, as described above, the vehicle diagnostics monitor can connect to the OBD connection and can receive various vehicle parameters provided by the onboard computer(s). The marketing system can then determine which services or repairs, if any, may be recommended or needed for the vehicle.

Additionally or alternatively, the system can correlate the recommended/needed services and/or repairs with advertising or marketing materials of one or more automotive shops that can perform such services or repairs. For instance, when the parameters indicate that the vehicle has traveled a predetermined number of miles since a pervious oil change, which is equal to or greater than a recommended number of miles between oil changes, the system can determine that an oil change is recommended. For simplicity, owners and operators of vehicles are referred to collectively as “owners.” The system also can correlate any available coupons or other promotional and/or advertising materials related to automotive oil changes and provide such material to the owner of the vehicle.

In addition to providing advertising and promotional materials, the system can notify the owner of the vehicle of any impending and/or upcoming recommended/needed service, maintenance, or repair. Hence, the system can create a mutually beneficial relationship between the owner of the vehicle on the one hand and automotive repair and service shops on the other hand. More specifically, the owner of the vehicle can use the system to receive relevant and timely information about the vehicle's service, maintenance, and repair needs as well as pricing and promotional information for satisfying those needs. For example, the system can inform an owner of a vehicle malfunction and what service is needed to remedy the malfunction. The automotive service and repair shops also can benefit from the system by providing marketing information for their respective services to vehicle owners that actually need such services or repairs. Accordingly, the system can enable a more efficient market place for automotive services and repairs.

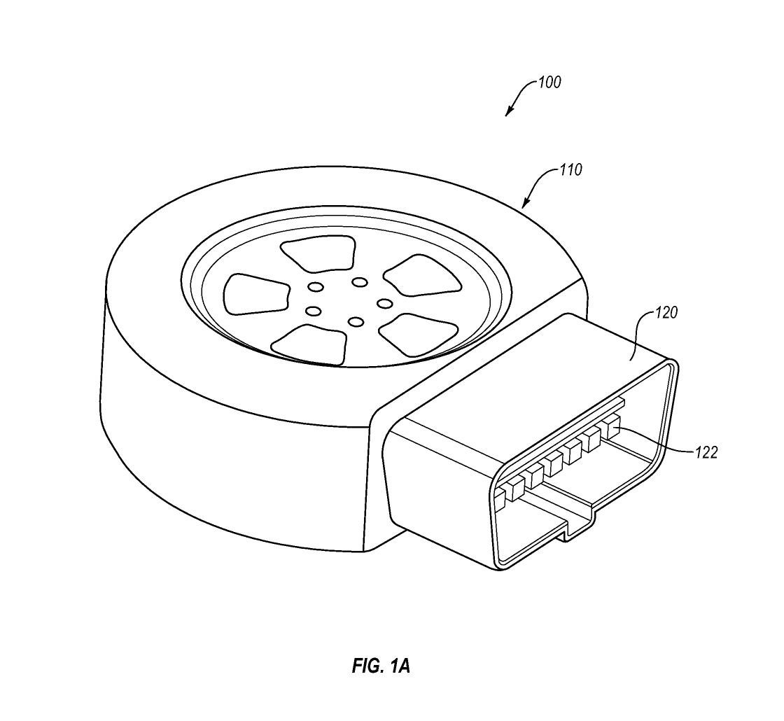

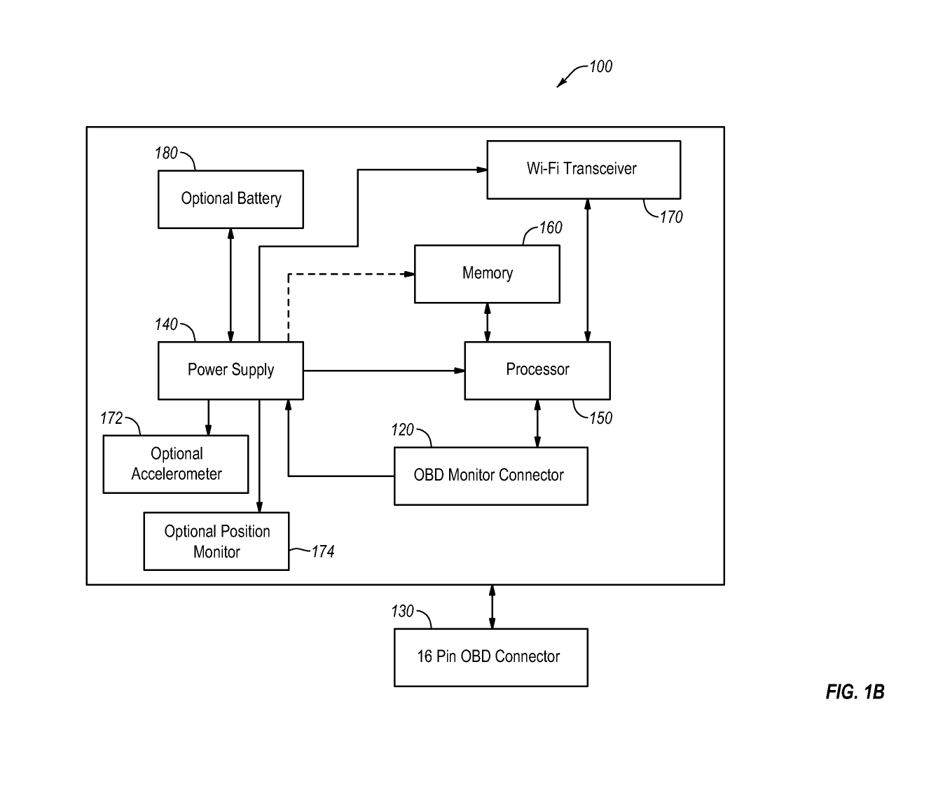

Referring now to the figures, FIGS. 1A and 1B illustrate an exemplary implementation of a vehicle diagnostics monitor 100. Particularly, FIG. 1A illustrates an outer casing 110 and a male connector portion 120 of the vehicle diagnostics monitor 100. The male connector portion 120 houses a plurality of pin connectors 122. Together, the male connector portion 120 and the pin connectors 122 are configured to connect to an OBD connection of the vehicle. As used herein, the term “OBD” refers to all of the On-Board Diagnostic connections and protocols, including but not limited to OBD-I, OBD-1.5, and OBD-II.

In at least one implementation, the outer casing 110 comprises a durable thermoplastic material, which can protect the internal components of the vehicle diagnostics monitor 100 from damage. In other implementations, however, the outer casing 110 can comprise any suitable material or combinations of materials. For instance, the outer casing 110 can comprise steel or other metal, which can provide further increased protection to the internal components of the vehicle diagnostics monitor 100.

Moreover, the outer casing 110 also can be flame resistant, such as to protect the internal components of the vehicle diagnostics monitor 100 in the event of a fire. For example, the outer casing 110 can ensure that the internal components of the vehicle diagnostics monitor 100 survive an accident without destroying the internal components. Hence, the vehicle diagnostics monitor may allow accident investigators to recover various vehicle parameters read by and stored on the vehicle diagnostics monitor 100 during vehicle's operation prior to the accident.

The male connector portion 120 can connect to a vehicle OBD connector 130, as illustrated in FIGS. 1B. A typical OBD connector contains 16 pins, each of which may have a designated function. The pin connectors 122 of the male connector portion 120 mechanically and electrically correspond with the pins in the OBD connector 130. Furthermore, the male connector portion 120 generally corresponds with the OBD connector 130, such as to provide a mechanical connection therebetween. For instance, in one implementation, the OBD connector 130 is a female connector and the male connector portion 120 fits into and couples in the female OBD connector 130.

In at least one implementation, the male connector portion 120 has 16 pin connectors, all of which electrically and mechanically correspond with the 16 pins of the OBD connector 130. Alternatively, however, the male connector portion 120 can have fewer than 16 pin connectors 122, which may satisfy the particular functions of the vehicle diagnostics monitor 100. Either way, the pin connectors 122 of the male connector portion 120 can correspond with the pins of the OBD connector 130, such that the vehicle diagnostics monitor 100 is in electronic communication with the OBD connector 130.

As noted above, the OBD connector 130 can receive various vehicle parameters from the onboard computer(s). The vehicle diagnostics monitor can then in turn receive the parameters through the OBD connector 130. That is, the pin connections of the OBD connector 130 can transmit vehicle information and/or vehicle parameters to the connector pins 122 of the vehicle diagnostics monitor 100. As used herein, the term “vehicle information” refers to any information related to or concerning the vehicle, which includes but is not limited to vehicle parameters, acceleration information, position information, VIN, unit ID, etc.

The pins of the OBD connector 130 can provide the following one or more data formats to the vehicle diagnostics monitor 100: CAN High J-2284; ISO 9141-2 K Line; CAN Low J-2284; J1850 Bus−; J1850 Bus+; ISO 9141-2 L Line; other data formats chosen by the manufacturer. Additionally, the OBD connector 130 (through its pin connections) can supply power to the vehicle diagnostics monitor 100. Particularly, the pins of the OBD connector 130 can provide connection to the vehicle's battery power as well as a ground connection (to the vehicle's chassis).

The vehicle diagnostics monitor 100 also can include a power supply 140, which can receive power from the OBD connector 130, through the male connector portion 120. The power supply 140 can distribute power to various internal components of the vehicle diagnostics monitor 100. In one or more implementations, the power supply 140 can convert the power provided at the OBD connector 130 to one or more desired operating voltages, as may be required by the internal components of the vehicle diagnostics monitor 100. Alternatively, however, the power supply 140 can simply distribute the power received from the OBD connector 130 to the various internal components of the vehicle diagnostics monitor 100 (to the extent that such internal components can operate at the voltage provided by the OBD connector 130, such as 12 V). For example, the power supply 140 can comprise a series of conductive pathways on a printed circuit board.

The vehicle diagnostics monitor 100 also can have various configurations and internal components that can vary from one implementation to another. For instance, in at least one implementation, the internal components of the vehicle diagnostics monitor 100 include a physical processor 150, a physical computer-readable storage device or memory 160, and a Wi-Fi transceiver 170. The processor 150, a computer-readable storage device 160, and/or Wi-Fi transceiver 170 can receive power from the power from the power supply 140, to the extent that such power is needed or required thereby.

The processor 150 can process the vehicle parameters in various data formats, as the vehicle parameters are provided at the OBD connector 130. In additional or alternative implementations, the processor 150 also can transmit vehicle parameters to the onboard computer(s) through the OBD connector 130. For example, the vehicle diagnostics monitor 100 can modify certain parameters (as made available or modifiable by the vehicle's manufacturer), to adjust or customize the vehicle's performance as desired. Accordingly, the processor 150 can provide two-way communication with the onboard computer(s) of the vehicle. In other words, the processor 150 can receive vehicle parameters read at the OBD connector 130 and can send vehicle parameters through the OBD connector 130 to the vehicle's onboard computer(s).

The processor 150 also may have a two-way electrical connection with the Wi-Fi transceiver 170. More specifically, the processor 150 can send data to and/or receive data from the Wi-Fi transceiver 170. As used herein, the term “data” is intended to encompass vehicle information as well as other information necessary or desirable during transmission of the vehicle information, including but not limited to the information typically incorporated into a network packet being for transmission over an Internet Protocol. Thus, the processor 150 can send the vehicle parameters received at the OBD connector 130, out through the Wi-Fi transceiver 170. Similarly, the processor 150 can send the vehicle parameters received from the Wi-Fi transceiver 170 (as further described below) out to the OBD connector 130.

In at least one implementation, the processor 150 may have a two-way electrical connection with the computer-readable storage device 160, which can allow the processor 150 to send data to and/or retrieve data from the computer-readable storage device 160. For example, the processor 150 can cause vehicle parameters received from the OBD connector 130 to be stored in the computer-readable storage device 160. Subsequently, the processor 150 can retrieve the vehicle parameters from the computer-readable storage device 160 and can send the retrieved vehicle parameters out through the Wi-Fi transceiver 170.

Similarly, the processor 150 can cause vehicle parameters received from the Wi-Fi transceiver 170 to be stored in the computer-readable storage device 160. Thereafter, the processor 150 can retrieve the stored vehicle parameters received from the Wi-Fi transceiver 170 and send the retrieved vehicle parameters to the OBD connector 130. Alternatively, however, the processor 150 can send the vehicle parameters received from the Wi-Fi transceiver 170 directly to the OBD connector 130.

In one or more implementations, the vehicle diagnostics monitor 100 also can include one or more accelerometers 172, which may detect the vehicle's acceleration. The processor 150 can then process and/or cause the vehicle acceleration information to be stored in the computer-readable storage device 160. In addition to, or in lieu of, sending the vehicle parameters, the vehicle diagnostics monitor 100 also can send the vehicle acceleration information.

In various additional or alternative implementations, the vehicle diagnostics monitor 100 also can include a position monitor 174, such as a GPS, an RF locator beacon, etc., which can provide approximate or a relatively precise location of the vehicle diagnostics monitor 100 and, consequently, of the vehicle. Furthermore, the vehicle diagnostics monitor 100 can use signals from one or more mobile or cellular phone towers to triangulate an approximate location. Additionally or alternatively, the vehicle diagnostics monitor 100 can receive, store, and transmit such information to a backend system, which can later process this information to obtain the approximate locations of the vehicle diagnostics monitor 100 at different times.

In at least one implementation, the vehicle diagnostics monitor 100 can include a transceiver capable of connecting to a cellular network in addition to or in place of the Wi-Fi transceiver 170. For example, the wireless transceiver that can connect to a cellular data network, such as a 3G or a 4G network. Accordingly, the vehicle diagnostics monitor 100 and transmit data through a wireless network to the backend system. Alternatively, the vehicle diagnostics monitor 100 can include, for example, a transceiver capable of connecting to a Bluetooth device. Hence, the vehicle diagnostics monitor 100 can connect to the vehicle owner's cellular phone via a Bluetooth connection and can obtain cellular phone tower positioning information therefrom.

Moreover, the vehicle diagnostics monitor 100 can time and date stamp each instance of the vehicle parameters, vehicle acceleration information, positioning information, and any other information gathered by the vehicle diagnostics monitor 100. In other words, the vehicle diagnostics monitor 100 can store time and date information at each instance any information is stored in the computer-readable storage device 160. Accordingly, the host computer can correlate particular occurrences recorded by the vehicle diagnostics monitor 100 with times of such occurrence as well as identify any changes in the vehicle.

For example, the processor 150 also can compare the vehicle information (e.g., vehicle parameters, acceleration and location information, etc.) stored in the computer-readable storage device 160 with newly acquired vehicle information, to identify any differences therein. Furthermore, the vehicle diagnostics monitor 100 can remove duplicate entries or information from the computer-readable storage device 160 (or can avoid storing such information). Accordingly, the vehicle diagnostics monitor 100 can maximize the amount of different information stored in the computer-readable storage device 160, which may have a finite storage capacity.

Once connected to the available network connection, the vehicle diagnostics monitor 100 can begin transmitting the information stored in the computer-readable storage device 160 over the available network connection to a host computer. For instance, the vehicle diagnostics monitor 100 can first transmit the information that was stored last (i.e., the information that has the latest date/time stamp), using a last in first out (LIFO) scheme. In other implementations, however, the vehicle diagnostics monitor 100 can transmit the stored information that has the earliest date/time stamp, using a first in first out (FIFO) scheme. In still further implementations, the vehicle diagnostics monitor 100 can transmit the stored information using other schemes. For example, when any DTC information is received, the vehicle diagnostics monitor 100 can automatically transmit it before transmitting any data packets not including DTC information.

In some instances, which may depend on the make and model of the vehicle, the OBD connector 130 can continuously supply power to the vehicle diagnostics monitor 100, both when the vehicle's ignition is ON and OFF. In other instances, the OBD connector 130 may continue to supply power to the vehicle diagnostics monitor 100 only when the vehicle's ignition is ON. In one or more implementations, the vehicle diagnostics monitor 100 may continue operating while the ignition is turned OFF. For example, the vehicle diagnostics monitor 100 can include an optional battery 180.

The power supply 140 can charge the battery 180 during the operation of the vehicle diagnostics monitor 100 (i.e., when the vehicle diagnostics monitor 100 is connected to and receives power from the OBD connector 130). Thus, the vehicle diagnostics monitor 100 can continue operating after the OBD connector 130 no longer supplies power to the vehicle diagnostics monitor 100. Consequently, the vehicle diagnostics monitor 100 can continue to search for available Wi-Fi network connections and/or can continue transmitting data to such connections, after the vehicle's ignition has been turned OFF.

As described above, the vehicle diagnostics monitor 100 can include a tangible or non-transitory computer-readable storage device 160. Accordingly, when the vehicle diagnostics monitor 100 cannot locate and/or connect to an available Wi-Fi network, vehicle parameters received during the operation of the vehicle diagnostics monitor 100 can be stored in the computer-readable storage device 160. Thus, when the vehicle diagnostics monitor 100 locates and connects to an available Wi-Fi network, the processor 150 can retrieve the stored vehicle parameters and can send the retrieved vehicle parameters over the available Wi-Fi network.

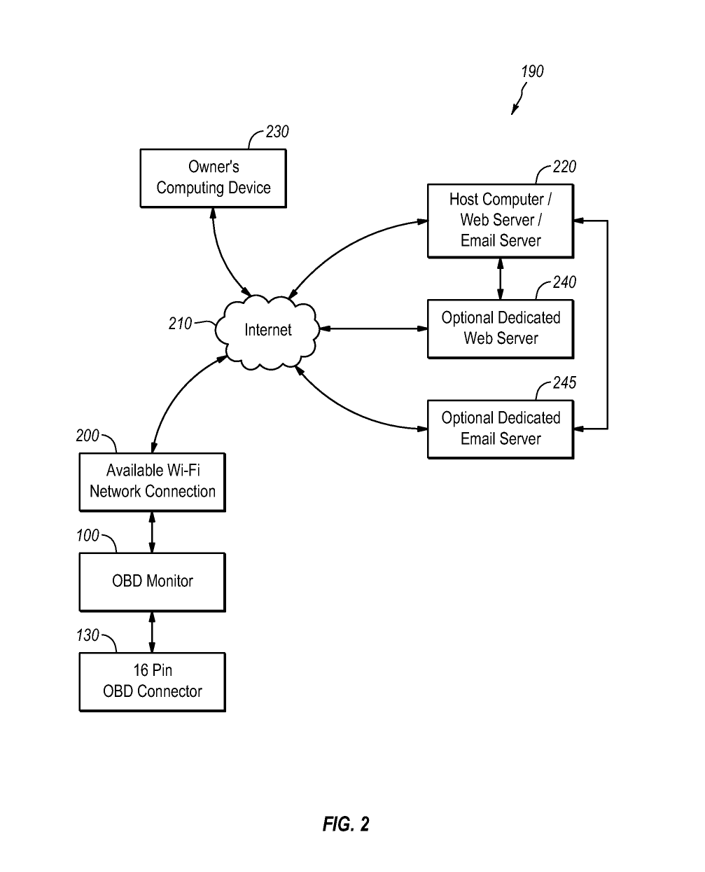

In at least one implementation, the vehicle diagnostics monitor 100 can use an available Wi-Fi network connection to send the vehicle information, including the vehicle parameters. FIG. 2, for instance, illustrates a system 190 that includes the vehicle diagnostics monitor 100 as well as other components that receive and use vehicle information from the vehicle diagnostics monitor 100. Particularly, FIG. 2 illustrates the system 190 for receiving marketing materials related to vehicle service, maintenance, repair, and combinations thereof.

As described above, the vehicle diagnostics monitor 100 can connect to the OBD connector 130, to receive the vehicle parameters. The vehicle diagnostics monitor 100 also can connect to an available Wi-Fi network connection 200. More specifically, the vehicle diagnostics monitor 100 can have a two-way connection with the available Wi-Fi network connection 200, such that the vehicle diagnostics monitor 100 can send data (e.g., vehicle information) to the available Wi-Fi network connection 200 and can receive data from the available Wi-Fi network connection 200.

The available Wi-Fi network connection 200 can be any Wi-Fi network that can be accessed by the vehicle diagnostics monitor 100, which may be a secured or an unsecured Wi-Fi network. For example, the available Wi-Fi network connection 200 can be an open Wi-Fi network connection that can allow connections to any compatible device. Alternatively, however, the available Wi-Fi network connection 200 also can be a secure Wi-Fi network connection, such as a Wi-Fi network using a WEP, WPA, WPA2, or another encryption system and/or requiring a password to allow connection. For instance, the owner or operator of the vehicle can have a secured Wi-Fi network available at home, and such Wi-Fi network may require a password to allow connection. The vehicle diagnostics monitor 100 can accept and/or store the corresponding password, which may be entered by the owner or operator of the vehicle and which can allow the vehicle diagnostics monitor 100 to connect to the home Wi-Fi network.

The available Wi-Fi network connection 200, in turn, can connect to the Internet 210. Hence, the vehicle diagnostics monitor 100 can send data through the available Wi-Fi network connection 200 and to the Internet 210. More specifically, the vehicle diagnostics monitor 100 can prepare (i.e., encode) and/or process the vehicle information stored in the memory of the vehicle diagnostics monitor 100 into one or more network packets.

The network packets can be sent using the Internet Protocol, through the available Wi-Fi network connection 200 to the Internet 210. Among other things, such network packets can specify a source IP address and a destination IP address for the packet. Moreover, the network packets also can include a unit ID, which can correspond with a particular vehicle diagnostics monitor 100.

Consequently, the vehicle diagnostics monitor 100 can direct the packets (and the data contained therein) to a backend system that is connected to the Internet 210. The backend system can include a host computer 220. In other words, the host computer 220 can be connected to the Internet 210 and can have a designated IP address. As noted above, the network packets sent by the vehicle diagnostics monitor 100 can include a destination IP address. Hence, the network packets are sent from the vehicle diagnostics monitor 100, through the available Wi-Fi network connection 200, and, subsequently, to the Internet 210 and to the final destination, based on the IP address designated in the network packets.

In some instances, the vehicle diagnostics monitor 100 also can encrypt the data sent in the network packets. Encryption of the network packets can provide increased security during the transfer thereof through the available Wi-Fi network connection 200 and the Internet 210. Furthermore, particularly when sending the vehicle parameters over an open, available Wi-Fi network connection 200, encrypting the data comprising the vehicle parameters can facilitate secure transfer of such vehicle parameters to a desired destination.

The host computer 220 can process and decode the network packets received from the vehicle diagnostics monitor 100. Particularly, from the network packets, the host computer 220 can obtain the data sent by the vehicle diagnostics monitor 100. As noted above, the data in the network packets can comprise information that is or was stored in the memory of the vehicle diagnostics monitor 100, which can include the vehicle parameters (such as DTCs), acceleration information, position information, time and date stamp, etc.

Additionally, in some instances, the data in the network packets may be encrypted by the vehicle diagnostics monitor 100. Accordingly, the host computer 220 also can decrypt the data to obtain the vehicle parameters therefrom. Moreover, after decoding and (in some instances) decrypting, the host computer 220 also can obtain the source IP address of network packets as well as the unit ID of the vehicle diagnostics monitor 100 that sent the network packets.

Therefore, the host computer 220 can correlate the vehicle parameters received in the network packets with a particular vehicle diagnostics monitor 100 and, consequently, with a particular vehicle. In other words, a particular vehicle diagnostics monitor 100 can be assigned to a particular vehicle, which can be identified by a VIN, vehicle description (make, year, model, color), registration number (i.e., plate number), other identifying vehicle information, and combinations thereof. Subsequently, the host computer 220 can process the vehicle parameters to obtain, for example, the vehicle's fault codes, which can indicate problems that the vehicle may be experiencing. Additionally or alternatively, the host computer 220 can correlate the source IP address of the network packets with a geographic location of such IP address, thereby identifying an approximate or specific location of the vehicle.

Accordingly, as further described below, the host computer 220 can provide various information about the vehicle to the vehicle's owner. For example, the host computer 220 can make such information available over the Internet. More specifically, the host computer 220 can include a Web server, which can host a vehicle information website that provides the vehicle's owner with access to the information about the vehicle.

For instance, the vehicle's owner can have a computing device 230 that may be connected to the Internet and can be capable of accessing online content, such as accessing a website, receiving electronic mail, etc. The owner's computing device 230 can be substantially any device capable of connection to the Internet and accessing online content. Examples of the computing device 230 devices include but are not limited to a computer (e.g., a personal computer, a notebook or laptop, a server, a mainframe computer, etc.) and a mobile device (e.g., a PDA, a mobile phone, a tablet, etc.). Hence, the owner can access the vehicle information website from the computing device 230 and can receive information about the vehicle therefrom.

Optionally, the backend system can include a dedicated web server 240, which can host the vehicle information website. Thus, the host computer 220 can transmit the vehicle information to the dedicated web server 240. Subsequently, the dedicated web server 240 can allow the vehicle's owner to access the vehicle information through the vehicle information website.

Thus, the owner can use the computing device 230 to connect to the vehicle information website, which can be hosted on the host computer 220. As further described below, the vehicle information website can allow the owner to view information about the vehicle, which can be obtained from the data received by the host computer 220 from the vehicle diagnostics monitor 100. For example, the host computer 220 can provide the owner with information about the vehicle's recommended service, maintenance, repairs, and combinations thereof.

In at least one other implementation, the backend system of the system 190 can include an email server. Additionally or alternatively, the email server can be hosted as an optional dedicated email server 245. The email server also can send alert information to the vehicle's owner. For example, the emails can alert the owner that the vehicle is due for or needs service, maintenance, or repairs, and can identify particular repairs or service for the vehicle. The email server also can send marketing and advertising emails to the vehicle's owner related to the recommended service, maintenance, repairs, and combinations thereof for the vehicle.

Based at least in part on the fault codes obtained from the vehicle parameters, the email server also can notify or alert the owner of various problems the vehicle may be experiencing. Additionally, the emails also can contain other vehicle information, as may be desired by the owner. For instance, the emails can contain information on various vehicle parameters (in addition to or in lieu of fault codes noted above), which can include odometer reading, maximum speed traveled during a period of time, accelerometer readings, position monitor readings, etc. Essentially any information the owner can access on the vehicle information website also can be sent to the owner in an email.

Furthermore, such emails can be sent at regular intervals, as may be designated by the owner. Additionally or alternatively, the emails can be sent upon occurrence of a predetermined event or events. Moreover, in one or more additional implementations, the same information made available to the owner in the emails also can be sent to the owner using other modes of communication. For example, the host computer 220 can (directly or indirectly, such as through another computer or server) send text messages using (e.g., using short message service (SMS))) or place a call to the owner.

Whether emails, text messages, or other modes of sending information to the owner are employed, the owner can receive the above described information on the computing device 230. Moreover, depending on the particular type of the computing device 230 used by the owner, the owner also may respond to the messages, requesting changes to settings of the owner's account. For instance, the owner can request to change frequency of and/or condition upon which the information is sent to the owner. In at least one implementation, such request can be automatically processed by the host computer 220 and/or by another computer in communication with the host computer 220.

In at least one implementation, the host computer 220 also can send data (e.g., vehicle parameters) to the vehicle diagnostics monitor 100. For example, the owner can access the vehicle information website, hosted on the host computer 220, and can request a change of vehicle parameters (as made available by the vehicle's manufacturer). Subsequently, the host computer 220 can send such request to the vehicle diagnostics monitor 100, through the Internet 210 and the available Wi-Fi network connection 200. Thereafter, the vehicle diagnostics monitor 100 can send the request for change to the OBD connector 130, which can transmit the request to the onboard computer(s).

Moreover, as noted above, in some instances the vehicle diagnostics monitor 100 may communicate with the host computer 220 while the vehicle has been turned OFF (i.e., using battery power). Accordingly, the vehicle diagnostics monitor 100 can store such request for changes and new or modified vehicle parameters in the memory. Then, the vehicle diagnostics monitor 100 can recognize when the vehicle has been turned ON (e.g., by sensing that the OBD connector 130 began providing power to the power supply of the vehicle diagnostics monitor 100). When the vehicle has been turned ON, the vehicle diagnostics monitor 100 can then send the request as well as the new and/or modified vehicle parameters to the OBD connector 130.

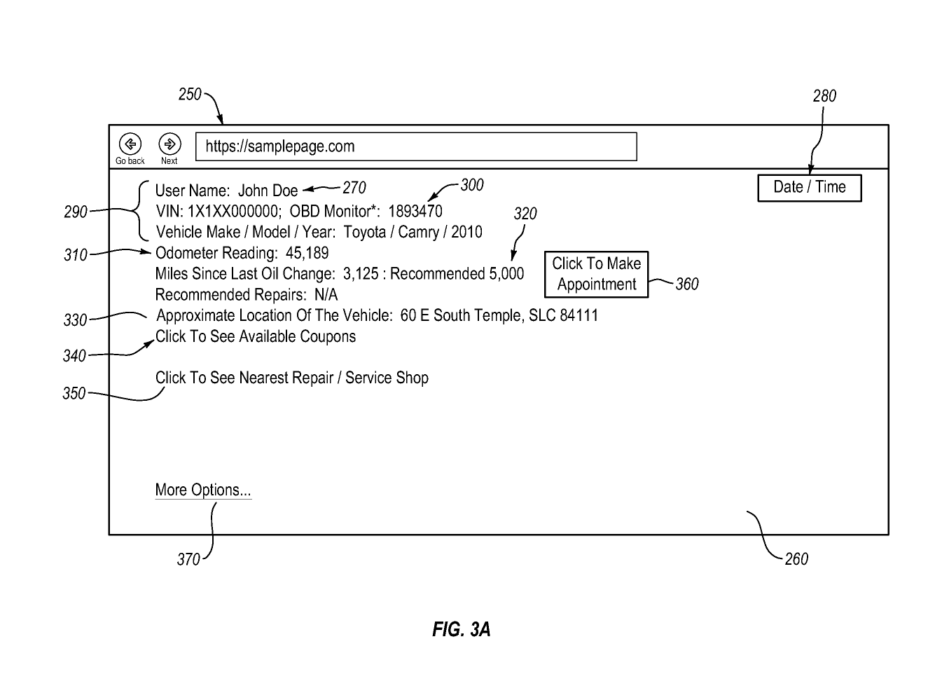

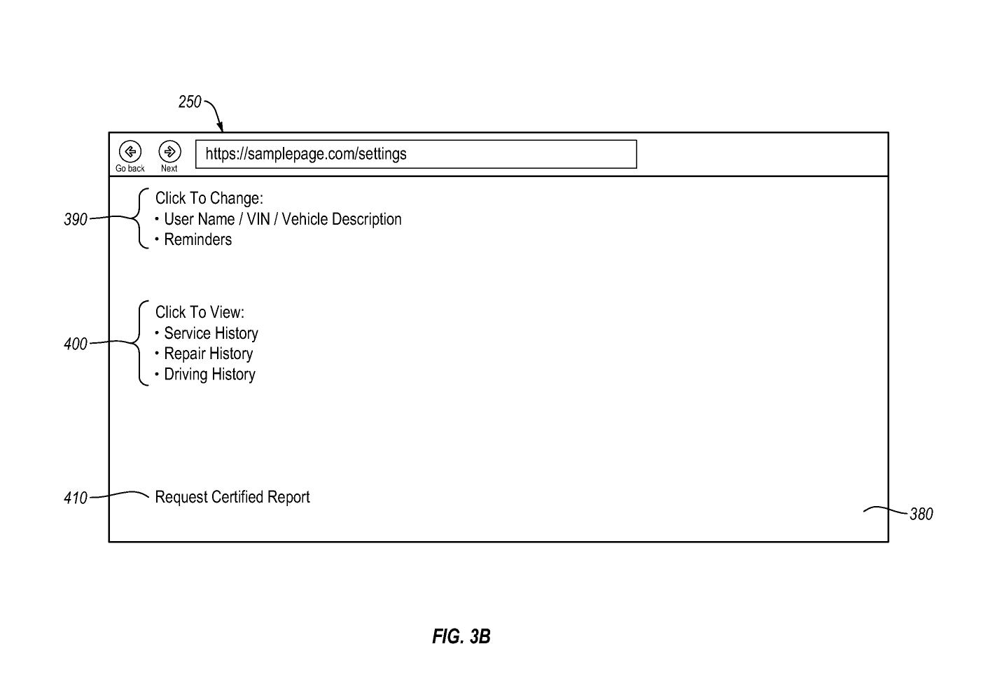

As described above, the owner can access vehicle information, which was was read by the vehicle diagnostics monitor 100 and sent to the backend system, by accessing the vehicle information website. Exemplary user interfaces of a vehicle information website 250 are illustrated in FIGS. 3A and 3B. Particularly, FIG. 3A illustrates a main page 260 of the vehicle information website 250. For example, the vehicle information website 250 can require the owner to provide accurate user name and password information before displaying the main page 260.

Once accessed, the main page 260 can provide vehicle information to the owner as well as allow modifying the owner's account settings. Amount other things; the main page 260 can display owner information 270, date and time 280 and vehicle description 290. Additionally, as noted above, the vehicle diagnostics monitor also can have a unit ID. The main page can display the unit ID at a location 300. Accordingly, when accessing the main page 260, the owner can verify that the vehicle information website displays information for a correct vehicle. The main page 260 also can display the vehicle's odometer reading 310.

Furthermore, the backend system can store the vehicle parameters as well as other information about the vehicle in a database. As used herein, the term “database,” refers generally to a collection of stored data, which may be stored in an organized and/or structured manner, such as an SQL database, or maybe stored in an unorganized and unstructured manner. In at least one implementation, the backend system also can store service, maintenance, and repair information and dates the same were performed on the vehicle. Accordingly, the backend system can use the stored information to determine whether vehicle service, repair, and/or maintenance should be recommended. For example, the backend system can calculate the number of miles that the vehicle traveled since the last oil change. Thus, the backend system also can determine whether an oil change should be recommended, based on a predetermined mile interval 320.

In one or more implementations, the owner can modify parameters used for determining whether to recommend vehicle service, maintenance, and/or repair. For instance, the main page 260 can allow the owner to modify the predetermined mile interval 320. Moreover, the backend system can utilize other information to determine whether the vehicle service, maintenance, and/or repair should be recommended (e.g., to determined whether to recommend an oil change).

In one or more implementations, the backend system can use accelerometer, speed, and location information to determine the recommended mile interval 320. More specifically, the backend system can determine an approximate breakdown of the engine oil based on the maximum speed traveled by the vehicle and frequency of such speeds, average rates of acceleration, and vehicle's geographic elevation and approximate oxygen level. Consequently, the owner may allow the backend system to calculate the recommended mile interval 320 or may set the same to be static.

The main page 260 also can display the vehicle's approximate location information 330, which can be determined by the vehicle diagnostics monitor and/or the host computer, as described above. Hence, if the owner cannot locate the vehicle (e.g., due to a theft or other unfortunate circumstances), the owner can use the main page 260 to determine the approximate location of the vehicle. Additionally, as noted above, among other things, the backend system can use the source IP address to determine the vehicle's approximate location 330. Particularly, the backend system can access a list of locations that correspond with the particular IP addresses and, thereby, determine the vehicle's approximate location 330.

Furthermore, the backend system also can have relatively precise locations for certain known IP addresses, which the backend system can use to determine the vehicle's location. For example, the backend system can store the IP address of the owner's home network. Hence, when the vehicle diagnostics monitor accesses the owner's home network and sends data to the backend system, the IP address can identify the location of the vehicle diagnostics monitor (and, thus, of the vehicle) as the owner's home.

The main page 260 also can provide the owner with information about available coupons 340 or other marketing material. For instance, the main page 260 can provide information about coupons for the vehicle's recommended service, maintenance, and/or repair. In one or more implementations, the backend system can determine a recommend/needed service or repair (oil change, brake replacement, manufacturer mile based recommended service, engine service,

Such coupons can be based on the vehicle's approximate location 330. More specifically, the main page 260 can display the nearest repair and or service shop's available coupons 340. Additionally or alternatively, the main page 260 also can display other coupons (e.g., unrelated to the owner's vehicle) for goods and services, which may be available near the approximate location 330 of the owner's vehicle.

In other implementations, the main page 260 also can display nearest service and repair shops 350 based on the vehicle's approximate location 330. Also, the main page 260 can allow the owner to make a service, maintenance, and/or repair appointment. For example, the main page 260 can provide a link 360 for making an appointment. Hence, the backend system can receive requests for and setup owner's appointment with a service/repair shop, for a particular date and time of the appointment and reason.

In one or more implementations, the vehicle information website 250 can allow the owner to access additional options by clicking on a “more options” 370 link. Subsequently, the backend system can present the owner with a secondary page 380 (FIG. 3B) that may provide additional information and/or configuration options. For example, the secondary page 380 can allow the owner to change the user name and/or vehicle description (with which the vehicle diagnostics monitor is associated) at change links 390.

Accordingly, the user can use the same OBD for multiple vehicles, by unplugging the vehicle diagnostics monitor from a first vehicle and plugging it into a second vehicle. Furthermore, the backend system can retain information about the different vehicles associated with the vehicle diagnostics monitor. For instance, when the user reconnects the vehicle diagnostics monitor to the first vehicle and updates the user name and/or vehicle description on the vehicle information website 250, the backend system can retrieve previously saved information about the first vehicle. Accordingly, the owner can receive information on recommended service, maintenance, and repairs, such as when the first vehicle is due for an oil change. Similarly, the user can add and/or delete vehicles associated with the vehicle diagnostics monitor.

In one or more implementations, the backend system can verify accuracy of the owner's vehicle descriptions. For example, the backend system can compare the powertrain information obtained from vehicle diagnostics monitor to the powertrain of the vehicle described by the owner. Thus, the backend system can provide a certified report on for particular vehicle, as further described below, while taking measures to assure that the vehicle diagnostics monitor was in fact connected to such vehicle.

The change links 390 also can allow the owner to modify and/or set reminders. In one or more embodiments, the owner can choose to be reminded at particular times about an upcoming recommended oil change or other service or maintenance items. Moreover, the owner may request to receive reminders or alerts about certain problems with the vehicle, as described above.

Additionally or alternatively, the owner can set or modify the particular mode of delivery for the reminders. For instance, the owner may choose to receive reminders and/or advertising material via email. Alternatively, as noted above, the owner may choose to receive text message reminders, phone call reminders (e.g., automated phone calls), or other reminders. The owner also may choose to receive reminders only on the vehicle information website 250.

Additionally, the vehicle information website 250 can allow the owner to view the vehicle's history, which may be stored on the backend system. More specifically, the owner can view the service history of the vehicle. For example, the owner can view when the oil changes were performed (as compared to recommended intervals), what type of oil was used, etc. The owner also can view history of repairs performed on the vehicle.

Furthermore, the secondary page 380 also can allow the owner to access driving history of the vehicle. For instance, the driving history of the vehicle can include dates and times the vehicle was at particular locations, acceleration history, maximum, minimum, and average speeds of the vehicle, etc. Such implementation can allow the owner to monitor use of the vehicle. For example, the owner can monitor how and when the owner's children use the vehicle.

In further implementations, a third party can provide a certified vehicle report in response to the owner's request for a certified report at location 410. The report may include service and repair history (e.g., the report may show the vehicle's oil changes as compared with recommended oil changes) and driving history (e.g., maximum speeds/acceleration of the vehicle). Particularly, when the owner is attempting to sell the vehicle, the third party report can provide great insight into the vehicle's condition to a potential buyer, which may increase the resale value of the owner's vehicle.

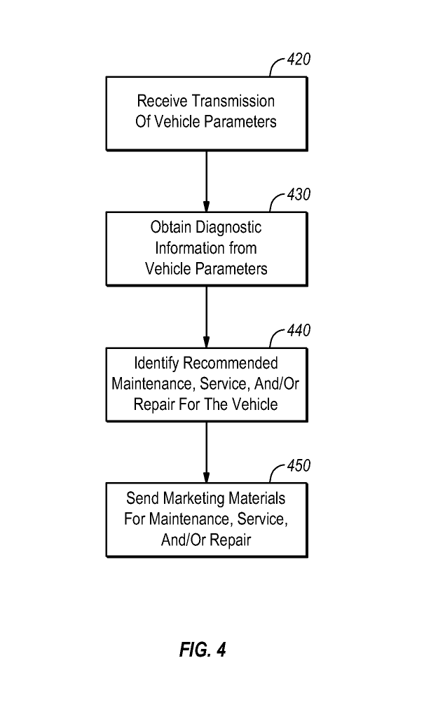

FIGS. 1-3B, the corresponding text, and the examples, provide a number of different system and devices for receiving marketing information about the vehicle's recommended service, maintenance, repairs, and combinations thereof. In addition to the foregoing, implementations of the present invention also can be described in terms of flowcharts comprising acts and steps in a method for accomplishing a particular result. For example, FIG. 4 illustrates a flowchart of one exemplary method for providing marketing material's to the vehicle's owner.

For example, the method illustrated in FIG. 4 can include an act 420 of receiving a transmission of vehicle parameters. For example, a backend system can receive a transmission of vehicle parameter readings from a vehicle diagnostics monitor installed on a vehicle. As described above the vehicle diagnostics monitor can query the vehicle parameters from one or more on-board computers on the vehicle. Subsequently the vehicle diagnostics monitor can transmit the vehicle parameters, for example, using an available Wi-Fi network. Accordingly, in one or more implementations, the host computer can receive a transmission of a vehicle's parameter readings from a vehicle diagnostics monitor installed on the vehicle.

The method also may include an act 430 of obtaining information from vehicle parameters. For example, the host computer can decode the vehicle parameters to obtain vehicle information, such as DTCs, statistics about the vehicle or other information. In one implementation, the backend system can use the vehicle parameters to obtain fault codes and information about operability of the vehicle's systems. Thus, for instance, the host computer can obtain diagnostic information about the vehicle by decoding the vehicle's parameter readings received from the vehicle diagnostics monitor based on a predetermined protocol.

Moreover, the method can include an act 440 of identifying recommended maintenance, service, and/or repair for the vehicle. More specifically, the backend system can use the diagnostic information to identify service, maintenance, and repairs that may be recommended to the vehicle's owner. In one or more implementations, the method can comprise determining that recommended maintenance, service, or repair for the vehicle based on the vehicle's diagnostic information received from the vehicle diagnostics monitor and one or more preferences selected by the vehicle's owner or operator. In other words, the backend system can identify one or more of recommended maintenance, service, and repair for the vehicle based at least in part on the vehicle's diagnostic information.

In at least one implementation, the method can include an act 450 of sending marketing materials for maintenance, service, and/or repair. More specifically, the marketing materials can be related to and/or based on the recommendations for service, maintenance, and/or repair made to the vehicle's owner. Hence, the host computer can send marketing materials for the identified one or more of recommended maintenance, service, and repair to one or more of the vehicle's owners and operators.

For example, act 450 can comprise selecting a coupon for a discount for the identified one or more recommended maintenance, service, or repair. More specifically, act 450 can comprise selecting a vehicle service provider from a list of vehicle service providers based on an approximate location of the vehicle or an address associated with the vehicle's owner or operator. Act 450 can then comprise selecting a coupon associated with the selected vehicle service provider. Act 450 can further comprise emailing the coupon to an email address associated with the vehicle's owner or operator, posting the coupon on a webpage associated with an account of the vehicle's owner or operator, or otherwise providing the coupon to the vehicle's owner or operator.

The implementations of the present invention can comprise a special purpose or general-purpose computing systems. Computing systems may, for example, be handheld devices, appliances, laptop computers, desktop computers, mainframes, distributed computing systems, or even devices that have not conventionally considered a computing system, such as DVD players, Blu-Ray Players, gaming systems, and video converters. In this description and in the claims, the term “computing system” is defined broadly as including any device or system (or combination thereof) that includes at least one physical and tangible processor, and a physical and tangible memory capable of having thereon computer-executable instructions that may be executed by the processor.

The memory may take any form and may depend on the nature and form of the computing system. A computing system may be distributed over a network environment and may include multiple constituent computing systems. In its most basic configuration, a computing system typically includes at least one processing unit and memory. The memory may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well. As used herein, the term “module” or “component” can refer to software objects or routines that execute on the computing system. The different components, modules, engines, and services described herein may be implemented as objects or processes that execute on the computing system (e.g., as separate threads).

Implementations of the present invention may comprise or utilize a special purpose or general-purpose computer including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: computer storage media and transmission media.

Computer storage media includes RAM, ROM, EEPROM, CD-ROM or other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

We claim:

1. At a computer system, the computer system including one or more processors and a memory, a method of delivering marketing material to owners and operators of vehicles, the method comprising the acts of:
receiving a transmission of a vehicle parameter readings from a vehicle diagnostics monitor installed on a vehicle;
obtaining diagnostic information about the vehicle by decoding the vehicle parameter readings received from the vehicle diagnostics monitor;
identifying one or more of a recommended maintenance, service, or repair for the vehicle based at least in part on the vehicle's diagnostic information; and
sending marketing materials for the identified one or more recommended maintenance, service, or repair to the vehicle's owner or operator.

2. The method as recited in claim 1, wherein the marketing materials comprise a coupon for a discount for the identified one or more recommended maintenance, service, or repair.

3. The method as recited in claim 2, wherein sending marketing materials comprises emailing the coupon to an email address associated with the vehicle's owner or operator.

4. The method as recited in claim 2, wherein sending marketing materials comprises posting the coupon on a webpage associated with an account of the vehicle's owner or operator.

5. The method as recited in claim 1, further comprising:
selecting a vehicle service provider from a list of vehicle service providers based on an approximate location of the vehicle or an address associated with the vehicle's owner or operator; and
sending marketing materials from the selected vehicle service provider.

6. The method as recited in claim 1, further comprising determining that a recommended maintenance, service, or repair for the vehicle based on the vehicle's diagnostic information received from the vehicle diagnostics monitor and one or more preferences selected by the vehicle's owner or operator.

7. The method as recited in claim 1, further comprising sending an alert to a phone number, email address, or webpage associated with the vehicle's owner or operator regarding a diagnostic trouble code received from the vehicle diagnostics monitor.

8. A system for receiving marketing materials related to vehicle service, maintenance, repair, and combinations thereof, the system comprising:
a vehicle diagnostics monitor having a system memory and a processor, the vehicle diagnostics monitor being configured to:
connect to an OBD or OBD-II connection of a vehicle;
query one or more vehicle parameters at the OBD or OBD-II connection of the vehicle,
store the one or more queried vehicle parameters in the system memory;
locate and access an available Wi-Fi network connection,
transmit the one or more stored vehicle parameters over the Internet through the available Wi-Fi network connection;
a backend system comprising a host computer connected to the Internet, the backend system being configured to:
receive the one or more transmitted vehicle parameters from the vehicle diagnostics monitor,
identify one or more of recommended maintenance, service, and repair for the vehicle based on the received vehicle parameters,
send marketing materials to an owner or operator of the vehicle based at least in part on the transmitted vehicle parameters; and
a communication device of the vehicle's owner or operator, the communication device being configured to receive the marketing materials from the backend system.

9. The system as recited in claim 8, wherein the backend system further comprises an email server configured to send an email with marketing materials.

10. The system as recited in claim 8, wherein the backend system further comprises a web server configured to display vehicle information based on the transmitted vehicle parameters on webpage associated with the vehicle's owner or operator.

11. The system as recited in claim 8, wherein the backend system further comprises a database including available coupons.

12. The system as recited in claim 8, wherein the vehicle diagnostics monitor is further configured to:
obtain vehicle acceleration information; and
transmit the vehicle acceleration information to the backend system.

13. The system as recited in claim 12, wherein the backend system is further configured to make the vehicle acceleration information available to the communication device of the vehicle's owner or operator.

14. The system as recited in claim 8, wherein the backend system is configured to determine an approximate location of the vehicle based on an IP address associated with the Wi-Fi network connection.

15. The system as recited in claim 8, wherein the vehicle diagnostics monitor is further configured to transmit the one or more stored vehicle parameters over the Internet through the available Wi-Fi network connection while the vehicle is turned OFF.

16. The system as recited in claim 8, the backend system is configured to send an alert to a phone number, email address, or webpage associated with the vehicle's owner or operator regarding a diagnostic trouble code received from the vehicle diagnostics monitor.

17. A device for reading and transmitting vehicle information using a Wi-Fi network, the device comprising:
an interface configured to connect at an OBD or OBD-II connection of a vehicle;
a processor in electronic communication with the interface, wherein the processor is configured to query one or more vehicle parameters from the vehicle via the interface;
a memory in electronic communication with the processor, wherein the memory is configured to receive and store the one or more vehicle parameters;
a Wi-Fi transmitter in electronic communication with the processor, wherein the processor and the Wi-Fi transmitter are configured to cooperate and to access an available Wi-Fi network connection for transmitting the one or more vehicle parameters over the available Wi-Fi network connection; and
a power supply configured to receive power from the interface and to transmit power to one or more of the processor, memory, and the Wi-Fi transmitter.

18. The device as recited in claim 17, further comprising an accelerometer in electronic communication with the processor, wherein:
the vehicle information comprises acceleration information; and
the accelerometer and the processor are configured to cooperate and to obtain the acceleration information.

19. The device as recited in claim 17, further comprising a position monitor in electronic communication with the processor, wherein:
the vehicle information comprises position information; and
the position monitor and the processor are configured to cooperate and to obtain the position information.

20. The device as recited in claim 17, further comprising a battery, and wherein the power supply is configured to charge the battery.
